(19) United States
(12) Patent Application Publication
(10) Pub. No.: US 2025/0092605 A1
(43) Pub. Date: Mar. 20, 2025

(54) LIQUID CRYSTAL POLYMER POWDER, LIQUID CRYSTAL POLYMER FILM, AND METHOD OF PRODUCING SAME

(71) Applicant: Murata Manufacturing Co., Ltd., Nagaokakyo-shi (JP)

(72) Inventors: Narimichi MAKINO, Nagaokakyo-shi (JP); Tatsuya YAMADA, Nagaokakyo-shi (JP); Yuta NAKANISHI, Nagaokakyo-shi (JP); Yuya IDA, Nagaokakyo-shi (JP)

(21) Appl. No.: 18/961,935

(22) Filed: Nov. 27, 2024

Related U.S. Application Data
(63) Continuation of application No. PCT/JP2023/018959, filed on May 22, 2023.

(30) Foreign Application Priority Data
May 27, 2022 (JP) 2022-087056

(51) Int. Cl. D21H 13/24; C08G 63/06; D21D 1/20; D21H 25/04

(52) U.S. Cl. CPC D21H 13/24; C08G 63/065; D21D 1/20; D21H 25/04; C08G 2250/00

(57) ABSTRACT

A liquid crystal polymer powder that contains fibrous particles including a liquid crystal polymer, and the melt viscosity of the liquid crystal polymer powder is 15 to 77 Pa·s.

### CROSS REFERENCE TO RELATED APPLICATIONS

The present application is a continuation of International application No. PCT/JP2023/018959, filed May 22, 2023, which claims priority to Japanese Patent Application No. 2022-087056, filed May 27, 2022, the entire contents of each of which are incorporated herein by reference.

### TECHNICAL FIELD

The present disclosure relates to a liquid crystal polymer powder, a method of producing the liquid crystal polymer powder, a liquid crystal polymer film, and a method of producing the liquid crystal polymer film.

### BACKGROUND ART

In recent years, as a new substrate material for printed wiring corresponding to next-generation high-speed transmission, a liquid crystal polymer (LCP), which is a material having a smaller transmission loss than the conventional material and excellent high-frequency characteristics, has attracted attention. LCP has excellent low dielectric constant characteristics, high heat resistance, and low water absorbability as compared with a polyimide resin which is a conventional substrate material, and thus can reduce loss of an electric signal or the like.

As a method of preparing an LCP film used for a printed wiring board or the like from a liquid crystal polymer, for example, a melt extrusion method and a solution casting method are known. The melt extrusion method is a method of forming a film by extruding a molten resin from an apparatus and bringing the resin into contact with a roll. The solution casting method is a method in which a varnish obtained by dissolving an LCP raw material such as an LCP pellet in a solvent is applied onto a flat belt and dried to form an LCP film.

Meanwhile, Patent Document 1 describes a method of producing a fibrillar liquid crystal polymer powder. In this method, first, a biaxially oriented film of a liquid crystal polymer is pulverized to provide a liquid crystal polymer (LCP) powder. Then, the obtained LCP powder is treated using a wet high-pressure crushing device to produce a fibrillated LCP powder. An LCP film can also be produced using such a fibrillar LCP powder as a raw material. It is considered that the improved bonding between fibrillar LCP particles after drying improves the folding strength of the LCP film.

Patent Document 2 (Japanese Patent Application Laid-Open No. H5-125160) discloses a resin composition exhibiting liquid crystallinity including two types of segments, and describes that the resin composition has a small temperature dependency of melt viscosity characteristics and excellent moldability, and that the resin can be used to provide a molded product with a favorable shape (a sheet with uniform thickness). Patent Document 2 describes that the resin composition has a melt viscosity of 800 poise (80 Pa·s) or more at a temperature of 245° C. and a shear rate of 1000 sec⁻¹.
Patent Document 1: Japanese Patent No. 5904307
Patent Document 2: Japanese Patent Application Laid-Open No. H5-125160

### SUMMARY OF THE DISCLOSURE

In a case where the liquid crystal polymer film is used for, for example, a substrate for a printed wiring board, it is desirable that the film has high folding strength in order to improve the reliability of the printed wiring board. In particular, in a case of use for a substrate for flexible printed wiring, high folding strength is required. For this reason, there is still room for improvement in the folding strength of the conventional liquid crystal polymer film.

In view of the above problem, an object of the present disclosure is to provide a liquid crystal polymer film having improved folding strength.

The liquid crystal polymer powder according to the first aspect of the present disclosure contains fibrous particles including a liquid crystal polymer, and the melt viscosity of the liquid crystal polymer powder is 15 to 77 Pa·s.

A liquid crystal polymer film according to a second aspect of the present disclosure contains a liquid crystal polymer, and the MIT fold number of the liquid crystal polymer film is 100 or more.

The present disclosure can improve the folding strength of a liquid crystal polymer film.

### BRIEF EXPLANATION OF THE DRAWINGS

FIG. 1 is photographs of liquid crystal polymer powder in Comparative Example 1 and Examples 1 to 9.

FIG. 2 is a view showing a relationship between the melt viscosity and the bulk density of the liquid crystal polymer powder in Examples and Comparative Examples.

FIG. 3 is a view showing the relationship between the melt viscosity of liquid crystal polymer powder and the folding strength (MIT fold number) of the liquid crystal polymer films in Examples and Comparative Examples.

FIG. 4 is a view showing a relationship between the melt viscosity of liquid crystal polymer powder and a linear expansion coefficient (CTE) of the liquid crystal polymer films in Examples and Comparative Examples.

FIG. 5 is a flowchart showing a step of producing the liquid crystal polymer powder of the embodiment.

FIG. 6 is a flowchart showing a step of producing the liquid crystal polymer film of the embodiment.

FIG. 7 is a flowchart showing a step of producing a fiber mat of the embodiment.

FIG. 8 is a view showing a matting step of matting liquid crystal polymer powder in the step of producing a fiber mat.

FIG. 9 is a view showing a step of irradiating a second surface of the fiber mat with light.

### DESCRIPTION OF THE PREFERRED EMBODIMENTS

Hereinafter, the liquid crystal polymer powder and the liquid crystal polymer film according to an embodiment of the present disclosure will be described.

### <Liquid Crystal Polymer Powder>

A liquid crystal polymer (LCP) powder according to an embodiment of the present disclosure contains fibrous particles including a liquid crystal polymer.

The liquid crystal polymer is, for example, a thermotropic liquid crystal polymer. In addition, a molecule of the liquid crystal polymer has a negative linear expansion coefficient (coefficient of thermal expansion: CTE) in an axial direction of a molecular axis and a positive CTE in a radial direction of the molecular axis. The liquid crystal polymer preferably has no amide bond.

Examples of the thermotropic liquid crystal polymer having no amide bond include a copolymer of parahydroxybenzoic acid, terephthalic acid, and dihydroxybiphenyl (a block copolymer of parahydroxybenzoic acid and ethylene terephthalate) having a high melting point and a low CTE, which is called a type-1 liquid crystal polymer, and a copolymer of parahydroxybenzoic acid and 2,6-hydroxynaphthoic acid (a block copolymer) having a melting point between a type-1 liquid crystal polymer and a type-2 liquid crystal polymer, which is called type-1.5 (or type-3).

### (Melt Viscosity)

The melt viscosity of the liquid crystal polymer powder is 15 to 77 Pa·s, and preferably 20 to 77 Pa·s. As a result, the fibrous particles constituting the liquid crystal polymer powder have a large aspect ratio (long fibers), and the folding strength of the liquid crystal polymer film produced using the liquid crystal polymer powder can be improved. In addition, a fiber mat produced using the liquid crystal polymer powder can have an improved breaking tension if the heat treatment temperature is equal to or less than the melting point of the liquid crystal polymer raw material. The porosity of the fiber mat can be adjusted by setting the heat treatment temperature to a value equal to or less than the melting point of the liquid crystal polymer raw material.

It is considered that as the melt viscosity of the LCP is higher, the molecular weight of the LCP is larger. When the molecular weight of LCP is large, the proportion of defects between polymers (LCP molecules) is low. It is considered that due to the influence of the molecular weight of the LCP, the proportion of defects, or the like, the LCP fibers (fibrous particles) in the LCP powder produced from the LCP raw material by the method described below are made long and the proportion of powder with a small aspect ratio is reduced, resulting in an increase in the proportion of fibrous particles. This is considered to reduce the CTE of the LCP film and improve the strength thereof.

The liquid crystal polymer powder with a melt viscosity of more than 80 Pa·s is difficult to actually prepare because the viscosity of the original LCP raw material is too high and there is a tendency for small amounts of foreign matter to be generated at the discharge outlet during pelletization.

The melt viscosity of the liquid crystal polymer powder is more preferably 30 to 70 Pa·s. In this case, the fibrous particles constituting the LCP powder have a larger aspect ratio (longer fibers), and the linear expansion coefficient of an LCP film produced using the LCP powder can be reduced.

The melt viscosity of the liquid crystal polymer powder is measured by a capilograph manufactured by Toyo Seiki Seisaku-sho, Ltd. in accordance with JIS K7199 under the following measurement conditions.

Temperature: Melting point of liquid crystal polymer +25° C.)

Shear rate: 1000 Sec⁻¹

Capillary: Length: 20 mm/diameter: 1 mm

The above Patent Document 2 refers to the relationship between the melt viscosity and moldability of LCP, but makes no mention whatsoever of the melt viscosity of LCP and the mechanical properties of LCP molded products.

When the melt viscosity of the liquid crystal polymer powder is 15 to 77 Pa·s or more, the fibrous particles constituting the liquid crystal polymer powder have a large aspect ratio (long fibers) and a thin average fiber thickness. As a result, the fibers become more physically entangled and the fiber diameter is smaller, thus resulting in melting and bonding at a lower temperature. Therefore, it is considered that the strength of the fiber mat is improved by heating below the melting point of the liquid crystal polymer raw material. The reason why thinner fibers melt at a lower temperature is considered to be that thinner fibers have a higher surface area in the volume thereof, which results in lower crystallinity and therefore melt at a lower temperature. The crystal has a regular structure, and thus it is considered that the existence thereof is less in areas such as the surface where bonds are broken and freedom is increased.

### (Fibrous Particles)

The fibrous particles contained in the LCP powder are not particularly limited as long as they contain a fibrous portion. The fibrous portion may be linear or may have branching or the like.

An average aspect ratio of the fibrous particles is preferably 10 to 500, more preferably 300 or less, and still more preferably 100 or less. An average diameter of the fibrous particles is more preferably 2 μm or less, and more preferably 1 μm or less.

The LCP powder containing such fine fibrous particles cannot be produced by a conventionally known method. For example, ultrafine fibers including LCP after cutting continuous long fibers of LCP produced by a conventional electrospinning method usually have an aspect ratio of more than 500.

The average diameter and average aspect ratio of the fibrous particles contained in the LCP powder are measured by the following method.

### (Measurement of Average Diameter and Average Aspect Ratio of Fibrous Particles)

The LCP powder to be measured is dispersed in ethanol to prepare a slurry containing 0.01% by mass of the LCP powder. At this time, the slurry is prepared such that a moisture content in the slurry was 1% by mass or less. Then, 5 μL to 10 μL of this slurry is dropped onto a slide glass, and then the slurry on the slide glass is naturally dried. The LCP powder is disposed on the slide glass by naturally drying the slurry.

Then, a predetermined region of the LCP powder disposed on the slide glass is observed with a scanning electron microscope to collect 100 or more pieces of image data of the particles constituting the LCP powder. In the collection of the image data, the region was set according to the size per particle of the LCP such that the number of image data was 100 or more. In addition, for each particle of the LCP, the image data is collected by appropriately changing a magnification of the scanning electron microscope to 500 times, 3,000 times, or 10,000 times in order to suppress leakage of the collection of the image data and occurrence of a measurement error.

Then, a longitudinal direction dimension and a width direction dimension of each particle of the LCP powder are measured using the collected image data.

A direction of a straight line connecting both ends of the longest path among paths that can be taken on one particle of the LCP powder photographed in each of the pieces of image data, that is, paths that pass from one end of the particle through substantially the center of the particle and reach an end opposite to the one end is defined as a longitudinal direction. Then, a length of a straight line connecting both ends of the longest path is measured as the longitudinal direction dimension.

In addition, a particle dimension of one particle of the LCP powder in a direction orthogonal to the longitudinal direction was measured at three different points in the longitudinal direction. An average value of the dimensions measured at these three points was taken as the width direction dimension (fiber diameter) per particle of the LCP powder.

Further, a ratio of the longitudinal direction dimension to the fiber diameter [longitudinal direction dimension/fiber diameter] is calculated and taken as the aspect ratio of the fibrous particles.

Then, the average value of the fiber diameters measured for 100 fibrous particles is taken as the average diameter.

In addition, the average value of the aspect ratios measured for 100 fibrous particles is taken as the average aspect ratio.

The fibrous particles may be contained in the LCP powder as an aggregate in which the fibrous particles are aggregated.

In addition, in the fibrous particles, the axial direction of the LCP molecules constituting the fibrous particles and the longitudinal direction of the fibrous particles tend to coincide with each other. It is considered that this is because, in a case where the LCP powder is produced through a fiberizing step described later, the axial direction of the LCP molecules is oriented along the longitudinal direction of the fibrous particles due to breakage between a plurality of domains formed by bundling the LCP molecules.

The bulk density of the LCP powder is preferably 2 to 5 mg/cm³, more preferably 2.5 to 4.5 mg/cm³, and still more preferably 2.5 to 4 mg/cm³.

In the LCP powder, a content (a number ratio) of particles other than the fibrous particles (massive particles that are not substantially fibrous) is preferably 20% or less. For example, when the LCP powder is placed on a plane, particles having a maximum height of 10 μm or less are fibrous particles, and particles having a maximum height of more than 10 μm are massive particles.

The LCP powder preferably has a D50 (an average particle size) value of 13 μm or less as measured by particle size measurement using a particle size distribution measuring device by a laser diffraction scattering method.

Preferably, the LCP has a melting point more than 300° C., more preferably more than 330° C. The “melting point” as used herein means an “endothermic peak temperature” as measured when the LCP is heated to 400° C. under an inert atmosphere, then cooled to normal temperature at a temperature decreasing rate of 40° C./min or more, and heated again at a temperature increasing rate of 40° C./min while an endothermic peak temperature measured using a differential scanning calorimeter. When the melting point (endothermic peak temperature) of the LCP exceeds 300° C., an LCP film excellent in heat resistance can be obtained. Further, when the LCP film is used as a circuit board, damage to the circuit board during repair using a soldering iron can be suppressed. The melting point of LCP powder is typically 1 to 3° C. lower than the melting point of the liquid crystal polymer raw material.

From the viewpoint of molding the LCP film, the melting point of the LCP is preferably lower than the decomposition temperature of the LCP, and is preferably, for example, 400° C. or less.

The liquid crystal polymer powder may further contain a zirconium compound. The zirconium compound is contained in an amount of preferably 0.001% by weight to 0.1% by weight, more preferably 0.003% by weight to 0.05% by weight with respect to the total amount of the liquid crystal polymer powder. Since the liquid crystal polymer powder contains a trace amount of the zirconium compound, the light irradiation efficiency can be increased by the light absorption characteristics of the zirconium compound when light is irradiated in the subsequent treatment step.

The zirconium compound refers to a compound containing a zirconium atom. Examples of the zirconium compound include zirconium acetate, zirconium hydroxide, and zirconium oxide, and among these, zirconium dioxide (zirconia) is preferably used. The zirconium compound contained in the liquid crystal polymer powder is preferably particulate, and the particle size is preferably 1 nm to 500 μm, and more preferably 10 nm to 100 nm. It is assumed that a zirconium compound used as a medium used during pulverizing a coarsely pulverized liquid crystal polymer is mixed in the production process of the liquid crystal polymer powder.

### <Liquid Crystal Polymer Film>

The liquid crystal polymer (LCP) film according to an embodiment of the present disclosure contains a liquid crystal polymer.

The LCP film of the present embodiment preferably has an MIT fold number of 100 or more times. The MIT fold number is the number of folds required to break a test film when the test film with a width of 10 mm and a thickness of 25 μm taken from an LCP film is subjected to an MIT folding fatigue test under the conditions of a load of 500 g, a radius of curvature of 0.2 mm, a folding angle of 135 degrees, and folding speed of 175 cpm.

As described above, the LCP film having a MIT fold number of 100 or more can be suitably used as a substrate for a flexible printed circuit (FPC), a diaphragm, an organic semiconductor substrate, an organic EL substrate, a damping plate, and the like as a circuit board. That is, the LCP film according to the present embodiment is preferably excellent in the folding strength from the viewpoint of being applicable to the above-described substrate and the like.

The in-plane (XY direction) linear expansion coefficient of the LCP film is preferably 20 ppm/° C. or less, and more preferably 18 to 20 ppm/° C. The linear expansion coefficient of the LCP film is the in-plane (XY direction) linear expansion coefficient of the LCP film measured according to JIS K 7197 by a TMA (thermomechanical analysis) method. Conditions of the TMA method are as follows: a temperature is raised from room temperature to 150° C. at 10° C./min under a nitrogen atmosphere, a load is 10 g, and a sample shape is a strip shape (5 mm×15 mm).

The thickness of the LCP film is preferably, for example, 5 μm to 250 μm.

The LCP film preferably has a water absorption rate of 0.2% by mass or less when immersed in water at normal temperature for 24 hours. As described above, if the water absorption rate is 0.2% by mass or less, the LCP film can be more suitably used as a circuit board member for high frequency. When the LCP film having a water absorption rate of 0.2% by mass or less is used as a circuit board member for high frequency, it is possible to suppress inclusion of water having an extremely high dielectric constant in a circuit board for high frequency, to suppress an increase in dielectric loss accompanying an increase in relative permittivity and dielectric loss tangent, and to suppress mismatch in characteristic impedance due to variation in dielectric constant and occurrence of transmission loss accompanying the mismatch. For example, an LCP film formed of a liquid crystal polymer in which an amine-derived structure is introduced into a molecular structure has a water absorption rate of more than 0.2% by mass because of relatively high water absorbency.

In the LCP film according to the present embodiment, a copper foil may be bonded to at least one surface, or copper foils may be bonded to both surfaces. In this case, the LCP film according to the present embodiment can be used as one laminated molded product, for example, as FCCL (Flexible Copper Clad Laminates) capable of forming a circuit by a subtract method.

### <Fiber Mat>

The fiber mat according to an embodiment of the present disclosure contains a liquid crystal polymer. A breaking tension of the fiber mat of the present embodiment is preferably 0.8 N/20 mm or more, and more preferably 1.0 N/20 mm or more. The breaking tension of the fiber mat may be 1.2 N/20 mm or more or 1.5 N/20 mm or more. According to the present disclosure, when heat treatment is performed at a temperature equal to or less than the melting point of the liquid crystal polymer, the breaking tension can be improved as compared with the fiber mat before heat treatment, and a fiber mat having a breaking tension of 1.0 N/20 mm or more can be obtained.

The breaking tension of the fiber mat can be measured using an autograph (AG-XDplus manufactured by Shimadzu Corporation). In this case, the width of the fiber mat during measurement is 20 mm.

The overall measuring weight of the fiber mat is approximately 30 to 40 g/m². The overall density of the fiber mat is, for example, 0.30 to 0.60 g/m³, and the density increases as a fused region of the liquid crystal powder polymer in the thickness direction increases.

The thickness of the fiber mat is approximately 50 to 100 μm, and the thickness decreases as the fused region of the liquid crystal powder polymer in the thickness direction increases.

### <<Liquid Crystal Polymer Powder, Liquid Crystal Polymer Film, and Method of Producing Fiber Mat>>

Hereinafter, a liquid crystal polymer powder and a method of producing a liquid crystal polymer film according to an embodiment of the present disclosure will be described.

### <Method of Producing Liquid Crystal Polymer Powder>

As shown in FIG. 5, the method of producing a liquid crystal polymer powder according to the present embodiment includes a coarsely pulverizing step (S11), a finely pulverizing step (S12), a coarse particle removal step (S13), and a fiberizing step (S14) in this order.

### (Preparation of LCP Raw Material)

In the method of producing a liquid crystal polymer powder of the present embodiment, first, a raw material (LCP raw material) including a liquid crystal polymer is prepared.

Examples of the LCP raw material include pelletized liquid crystal polymer uniaxially oriented, a film-shaped liquid crystal polymer biaxially oriented, and a powdery liquid crystal polymer. A pelletized or powdery liquid crystal polymer which is less expensive than the film-shaped liquid crystal polymer is preferable, and the pelletized liquid crystal polymer is more preferable from the viewpoint of production cost. In the present embodiment, the LCP raw material does not contain a liquid crystal polymer directly molded into a fibrous shape by an electrolytic spinning method, a melt blowing method, or the like. However, the LCP raw material may contain a liquid crystal polymer processed into a fibrous form by crushing a pelletized liquid crystal polymer or a powdery liquid crystal polymer.

The melt viscosity of the LCP material is 15 to 79 Pa·s, and preferably 20 to 79 Pa·s. The melt viscosity of the LCP raw material is basically the same as the melt viscosity of the liquid crystal polymer powder constituting the fibrous particles contained in the above LCP powder.

The melting point of the LCP raw material is preferably higher than 300° C., more preferably higher than 330° C., and still more preferably 350° C. or more. This can provide a liquid crystal polymer film containing a liquid crystal polymer having a melting point of more than 300° C. and excellent in heat resistance.

When the melting point of the LCP raw material is higher than 300° C., the LCP raw material is preferably a pelletized or powdery liquid crystal polymer. The film-shaped liquid crystal polymer is typically molded using a melt extrusion method. However, when an attempt is made to mold a film-shaped liquid crystal polymer by a melt extrusion method using a liquid crystal polymer having a melting point higher than 300° C., a large amount of fish-eyes of the liquid crystal polymer are generated or degradation due to decomposition occurs. This is because when a film-shaped liquid crystal polymer is to be molded by the melt extrusion method for the liquid crystal polymer having a melting point of higher than 300° C., it is necessary to heat the liquid crystal polymer to a temperature close to a decomposition temperature and continuously knead the liquid crystal polymer.

### (Coarsely Pulverizing Step: S11)

In the coarsely pulverizing step, the LCP raw material is coarsely pulverized. For example, the LCP raw material is coarsely pulverized with a cutter mill. A size of the particles of the coarsely pulverized LCP is not particularly limited as long as the particles can be used as a raw material in the finely pulverizing step described later. A maximum particle size of the coarsely pulverized LCP is, for example, 3 mm or less.

The method of producing an LCP film according to the present embodiment may not necessarily include the coarsely pulverizing step. For example, if the LCP raw material can be used as a raw material in the finely pulverizing step, the LCP raw material may be directly used as a raw material in the finely pulverizing step. However, when the melting point of the LCP raw material is higher than 330° C., it is preferable to perform the coarsely pulverizing step before the subsequent finely pulverizing step. In the coarsely pulverizing step, it is preferable to perform coarsely pulverizing in a state of being dispersed under high pressure. The number of times of dispersion treatment is preferably 1 to 50, and more preferably 1 to 10. Pulverization by high-pressure dispersion in the coarsely pulverizing step causes a granular finely pulverized liquid crystal polymer to be easily obtained in the subsequent step.

### (Finely Pulverizing Step: S12)

In the finely pulverizing step, the LCP raw material (after the coarsely pulverizing step) is pulverized in a state of being dispersed in liquid nitrogen to provide a granular finely pulverized liquid crystal polymer (finely pulverized LCP).

In the finely pulverizing step, it is preferable that the LCP raw material that is dispersed in the liquid nitrogen is pulverized using a medium. The medium is, for example, a bead. As the medium, for example, particles of zirconia can be used. The particle size of zirconia used as the medium is preferably 0.1 mm to 10 mm, and more preferably 1 mm to 8 mm. In the finely pulverizing step of the present embodiment, it is preferable to use a bead mill having relatively few technical problems from a viewpoint of handling liquid nitrogen. Examples of the apparatus that can be used in the finely pulverizing step include “LNM-08” that is a liquid nitrogen bead mill manufactured by AIMEX CO., LTD.

In the finely pulverizing step of the present embodiment, a pulverizing method in which the liquid crystal polymer is pulverized in the state of being dispersed in liquid nitrogen is different from a conventional freeze pulverizing method. Although the conventional freeze pulverizing method is a method of pulverizing a raw material to be pulverized while pouring liquid nitrogen onto the raw material to be pulverized and a pulverizing apparatus itself, most of the liquid nitrogen is vaporized at the time when the raw material to be pulverized is pulverized. That is, in the conventional freeze pulverizing method, most of the pulverized raw material is not dispersed in the liquid nitrogen at the time when the raw material to be pulverized is pulverized.

In the conventional freeze pulverizing method, heat of the raw material to be pulverized itself, the heat generated from the pulverizing apparatus, and the heat generated by pulverizing the raw material to be pulverized vaporize liquid nitrogen in an extremely short time. Thus, in the conventional freeze pulverizing method, the raw material during pulverization located inside the pulverizing apparatus has a temperature much higher than −196° C., which is the boiling point of liquid nitrogen. That is, in the conventional freeze pulverizing method, pulverization is performed under the condition that an internal temperature of the pulverizing apparatus is typically about −100° C. to 0° C. In the conventional freeze pulverizing method, when liquid nitrogen is supplied as much as possible, the temperature inside the pulverizing apparatus is approximately −150° C. at the lowest temperature.

For this reason, in the conventional freeze pulverizing method, for example, when a pelletized liquid crystal polymer (or coarsely pulverized product thereof) uniaxially oriented is pulverized, pulverizing proceeds along a plane substantially parallel to an axial direction of a molecular axis of the liquid crystal polymer, and thus, it is considered that a fibrous liquid crystal polymer having a significantly large aspect ratio and a fiber diameter much larger than 3 μm is obtained. That is, by the conventional freeze pulverizing method, when the pelletized liquid crystal polymer uniaxially oriented is pulverized, a granular finely pulverized liquid crystal polymer as used in the present embodiment cannot be obtained.

In the present embodiment, the raw material to be pulverized is pulverized in the state of being dispersed in liquid nitrogen, the raw material can be pulverized in a further cooled state as compared with the conventional freeze pulverizing method. Specifically, the raw material to be pulverized is pulverized at a temperature lower than −196° C., which is the boiling point of liquid nitrogen. The raw material to be pulverized having a temperature lower than-196° C. is pulverized, and brittle fracture of the raw material to be pulverized is repeated, and thus the grinding of the raw material proceeds. As a result, for example, when a uniaxially oriented liquid crystal polymer is pulverized, not only the fracture progresses in the plane substantially parallel to the axial direction of the molecular axis of the liquid crystal polymer, but also the brittle fracture progresses along the plane intersecting the axial direction, and thus the granular finely pulverized LCP can be obtained.

In the freeze pulverizing method of the present embodiment, the rotation speed of freeze pulverizing is preferably 1800 rpm or more, more preferably 2000 rpm or more, and still more preferably 2500 rpm or more. Adopting such a rotational speed causes the granular finely pulverized liquid crystal polymer having a desired aspect ratio to be easily obtained.

In the finely pulverizing step in the present embodiment, the liquid crystal polymer formed into granules by brittle fracture in liquid nitrogen is continuously subjected to impact with a medium or the like in a brittle state. Thus, in the liquid crystal polymer obtained in the finely pulverizing step in the present embodiment, a plurality of fine cracks are formed from the outer surface to the inside.

The granular finely pulverized LCP obtained by the finely pulverizing step preferably has a D50 of 50 μm or less as measured by a particle size distribution measuring apparatus by a laser diffraction scattering method. This makes it possible to suppress clogging of the granular finely pulverized LCP with the nozzle in the following fiberizing step.

### (Coarse Particle Removal Step: S13)

Then, in the coarse particle removing step, coarse particles are removed from the granular finely pulverized LCP obtained in the finely pulverizing step. For example, the granular finely pulverized LCP is sieved with a mesh to provide the granular finely pulverized LCP under the sieve, and the coarse particles contained in the granular finely pulverized LCP can be removed by removing the granular liquid crystal polymer on the sieve. A type of mesh may be appropriately selected, and examples of the mesh include a mesh having an opening of 53 μm. The method of producing a liquid crystal polymer powder according to the present embodiment may not necessarily include the coarse particle removal step.

### (Fiberizing Step: S14)

Then, in the fiberizing step, the granular liquid crystal polymer is crushed by a wet high-pressure crushing device to provide a liquid crystal polymer powder. In the fiberizing step, first, the finely pulverized LCP is dispersed in a dispersing medium for the fiberizing step. In the finely pulverized LCP to be dispersed, the coarse particles may not be removed, but it is preferable that the coarse particles are removed. Examples of the dispersing medium for the fiberizing step include water, ethanol, methanol, isopropyl alcohol, toluene, benzene, xylene, phenol, acetone, methyl ethyl ketone, diethyl ether, dimethyl ether, hexane, and mixtures thereof.

Then, the finely pulverized LCP in a state of being dispersed in the dispersing medium for the fiberizing step, that is, the paste-like or slurry-like finely pulverized LCP is passed through the nozzle in a state of being pressurized at high pressure. By allowing the finely pulverized LCP to pass through the nozzle at a high pressure, a shearing force or collision energy due to high-speed flow in the nozzle acts on the liquid crystal polymer, and the granular finely pulverized LCP is crushed, whereby the fiberization of the liquid crystal polymer proceeds, and the liquid crystal polymer powder that can be used in the method of producing a liquid crystal polymer film can be obtained. A nozzle diameter of the nozzle is preferably as small as possible within a range in which clogging of the finely pulverized LCP does not occur in the nozzle from a viewpoint of applying high shear force or high collision energy. Since the granular finely pulverized LCP in the present embodiment has a relatively small particle diameter, the nozzle diameter in the wet high-pressure crushing device used in the fiberizing step can be reduced. The nozzle diameter is, for example, 0.2 mm or less.

In the present embodiment, as described above, a plurality of fine cracks are formed in the granular finely pulverized LCP. Therefore, the dispersing medium enters into the finely pulverized LCP through fine cracks by pressurization in a wet high-pressure crushing device. Then, when the paste-like or slurry-like finely pulverized LCP passes through the nozzle and is positioned under normal pressure, the dispersing medium that has entered the finely pulverized LCP expands in a short time. When the dispersing medium that has entered the finely pulverized LCP expands, destruction progresses from inside of the finely pulverized LCP. Thus, fiberization proceeds to the inside of the finely pulverized LCP, and the molecules of the liquid crystal polymer are separated per domain disposed in one direction. As described above, in the fiberizing step according to the present embodiment, by defibrating the granular finely pulverized LCP obtained in the finely pulverizing step in the present embodiment, it is possible to obtain the liquid crystal polymer powder which has a low content of massive particles and is in the fine fibrous form as compared with the liquid crystal polymer powder obtained by crushing the granular liquid crystal polymer obtained by the conventional freeze pulverizing method.

In the fiberizing step in the present embodiment, the finely pulverized LCP may be crushed by a wet high-pressure crushing device to provide the liquid crystal polymer powder.

### <Method of Producing Liquid Crystal Polymer Film>

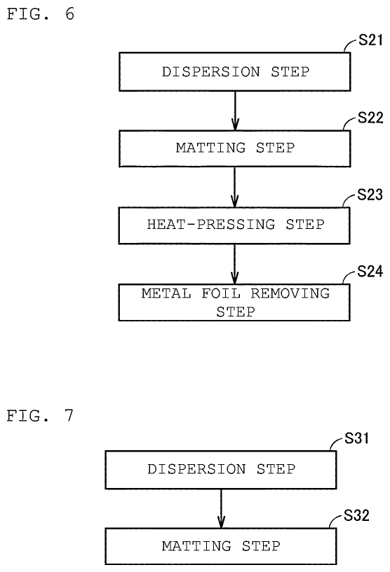

As shown in FIG. 6, the method of producing a liquid crystal polymer film according to the present embodiment includes a dispersion step (S21), a matting step (S22), a heat-pressing step (S23), and a metal foil removing step (S24).

### (Dispersion Step: S21)

In the dispersion step that is the first step of the method of producing a liquid crystal polymer film, the liquid crystal polymer powder is dispersed in a dispersing medium to form the liquid crystal polymer powder into a paste form or a slurry form. As described above, in the present embodiment, since the liquid crystal polymer powder in the ultrafine fiber form is used, the liquid crystal polymer powder can be dispersed in a highly viscous dispersing medium. As a result, a homogeneous liquid crystal polymer film can be produced.

Examples of the dispersing medium used in the dispersion step include water, terpineol, ethanol, and mixtures thereof. For example, when terpineol is used as the dispersing medium, a paste-like liquid crystal polymer powder is obtained. When a mixture of ethanol and water is used as the dispersing medium, a slurry-like liquid crystal polymer is obtained.

### (Matting Step: S22)

Then, in the matting step, the paste-like or slurry-like liquid crystal polymer powder is dried to form a liquid crystal polymer fiber mat. In one embodiment of the present disclosure, the matting step includes, for example, an application step and a drying step.

In the application step, a paste-like liquid crystal polymer powder is applied to a metal foil such as a copper foil. In the application step, a paste-like liquid crystal polymer powder is applied onto a metal foil such as a copper foil as described above; however, a polyimide film, a PTFE (polytetrafluoroethylene) film, or a composite sheet including a reinforcing material such as a glass fiber fabric and a heat-resistant resin may be used instead of the metal foil. This makes it easy to industrially produce a liquid crystal polymer film.

Then, the paste-like liquid crystal polymer applied to the copper foil is heated and dried in the drying step to vaporize the dispersing medium. The dispersing medium may be vaporized by suction. By the above heating and drying, a liquid crystal polymer fiber mat is formed on a metal foil such as a copper foil.

In the drying step, since the dispersing medium is gradually removed from the paste-like liquid crystal polymer powder, the entire thickness of the paste-like liquid crystal polymer powder gradually decreases during drying. Thus, the thickness of the liquid crystal polymer fiber mat is thinner than the entire thickness of the paste-like liquid crystal polymer formed on the copper foil. Specifically, in the present embodiment, the entire thickness of the paste-like liquid crystal polymer powder is about 700 μm, and the thickness of the liquid crystal polymer fiber mat is, for example, about 150 μm.

Further, as the total thickness of the paste-like LCP powder gradually decreases during drying, a longitudinal direction of the fibrous particles in the LCP powder changes. Specifically, among the fibrous particles, the fibrous particles having a longitudinal direction in a direction along the entire thickness direction of the paste-like liquid crystal polymer powder are inclined such that the longitudinal direction is directed in the in-plane direction of the copper foil. Therefore, there is anisotropy in the longitudinal direction of the fibrous particles in the formed liquid crystal polymer fiber mat.

In the matting step, a paste-like liquid crystal polymer may be further applied onto the liquid crystal polymer fiber mat formed on the metal foil in the drying step, and then the liquid crystal polymer may be dried to vaporize the dispersing medium. As described above, the matting step may include the application step and the drying step repeatedly in this order. Thus, a liquid crystal polymer fiber mat having a desired basis weight can be obtained.

The liquid crystal polymer fiber mat according to the present embodiment is formed such that the fibrous particles of the liquid crystal polymer powder are entangled with each other. The liquid crystal polymer fiber mat has a void between liquid crystal polymer powders. As described above, since the longitudinal direction of the fibrous particles in the liquid crystal polymer powder is inclined toward the in-plane direction of the copper foil as a whole, porosity of the liquid crystal polymer fiber mat relatively tends to be larger than that of a liquid crystal polymer mat obtained by matting a conventional liquid crystal polymer powder containing no fibrous particles. The porosity is, for example, 80% to 90%.

In the matting step in the present embodiment, a paste-like or slurry-like liquid crystal polymer powder may be formed into a liquid crystal polymer fiber mat by a papermaking method instead of the application step and the drying step. According to the papermaking method, it is not necessary to use a special dispersing medium used in the application step, for example, expensive terpineol. In the papermaking method, the dispersing medium used in the dispersion step can be recovered and reused. As described above, the liquid crystal polymer film can be produced at low cost by the papermaking method.

In the matting step using the papermaking method, specifically, first, a paste-like or slurry-like liquid crystal polymer powder is paper-made on a mesh, a nonwoven fabric-like microporous sheet, or a woven fabric. Then, the paste-like or slurry-like liquid crystal polymer disposed on the mesh is heated and dried to provide a liquid crystal polymer fiber mat.

### (Heat-Pressing Step: S23)

Then, in the heat-pressing step, the liquid crystal polymer fiber mat is heat-pressed to provide a liquid crystal polymer film. Specifically, in the heat-pressing step, the liquid crystal polymer fiber mat is heat-pressed together with a copper foil. Thus, the heat-pressing step also serves as a step of bonding the liquid crystal polymer film and the copper foil to each other, and thus a liquid crystal polymer film to which the copper foil is bonded can be obtained at low cost. In the case where the liquid crystal polymer fiber mat is heated for a long time in the heat-pressing step, it is preferable that the liquid crystal polymer fiber mat is heated and pressed in a vacuum. In addition, in the heat-pressing step, pre-pressing may be performed at a temperature of 220° C. or less before vacuum heat-pressing is performed. By performing the pre-pressing, the density of the fiber mat can be increased, and the linear expansion coefficient (CTE) of the liquid crystal polymer film can be reduced. The density of the fiber mat is preferably 0.1 to 1.5 g/cm³ and more preferably 0.3 to 1.4 g/cm³.

In the heat-pressing step, it is preferable to perform heat-pressing at a temperature lower by about 5° C. to 15° C. than the melting point of the liquid crystal polymer constituting the liquid crystal polymer powder. Heat-pressing is performed at a temperature lower by about 5° C. to 15° C. than the endothermic peak temperature, and as a result, sintering of the liquid crystal polymers easily proceeds.

In addition, in the heat-pressing step, a polyimide film, a PTFE film, or a composite sheet including a reinforcing material such as a glass fiber fabric and a heat-resistant resin may be interposed as a release film between a pressing machine used in the heat-pressing step and the liquid crystal polymer fiber mat.

In addition, in place of the polyimide film, an additional copper foil may be interposed between the pressing machine and the liquid crystal polymer fiber mat. In this case, it is possible to obtain a liquid crystal polymer film in which copper foils are bonded to both surfaces. The liquid crystal polymer film in which the copper foils are bonded to both surfaces can be used as a double-sided copper bonded FCCL.

An outer dimension of the liquid crystal polymer film molded by the heat-pressing step as viewed from the thickness direction, that is, a planar dimension along a film surface is substantially the same as that of the liquid crystal polymer fiber mat before heat-pressing. Then, by heat-pressing, among the fibrous particles of the liquid crystal polymer powder in the liquid crystal polymer fiber mat, the fibrous particles having the longitudinal direction in a direction along the thickness direction of the liquid crystal polymer fiber mat is heated while being pushed down in the in-plane direction of the copper foil. Since the liquid crystal polymer constituting the liquid crystal polymer powder has the axial direction of the molecule in the longitudinal direction of the fibrous particles, the axial direction of the molecule of the liquid crystal polymer is also pushed down in the in-plane direction of the copper foil. Thus, except for the molecules constituting the massive particles, the axial direction of each molecule constituting the liquid crystal polymer is oriented along the in-plane direction of the liquid crystal polymer film over the thickness direction of the liquid crystal polymer film. Therefore, in the molded liquid crystal polymer film, the main orientation direction of the molecules of the liquid crystal polymer tends to be along the in-plane direction of the copper foil, that is, the in-plane direction of the liquid crystal polymer film.

This is considered to reduce the in-plane linear expansion coefficient in the liquid crystal polymer film of the present embodiment. A liquid crystal polymer film having a low in-plane linear expansion coefficient has an advantage of excellent dimensional stability.

When the copper foil is bonded to the liquid crystal polymer film, the linear expansion coefficient of the liquid crystal polymer film can be reduced to the same level as the linear expansion coefficient (about 18 to 20 ppm/° C.) of the copper foil. As a result, defects such as warpage due to thermal shrinkage can be suppressed in the liquid crystal polymer film to which the copper foil is bonded.

Further, the liquid crystal polymer powder in the liquid crystal polymer fiber mat may be bonded to each other while the fibrous particles are entangled with each other. Thus, the liquid crystal polymer in the liquid crystal polymer film has a structure in which molecules are entangled with each other. Since the fibrous particle has a larger surface area than a spherical liquid crystal polymer having the same volume, a bonding area also increases when the liquid crystal polymer powders are bonded to each other by the heat-pressing step. Thus, the liquid crystal polymer film according to the present embodiment is improved in toughness and folding strength. In addition, by the heat-pressing step, the thickness of the liquid crystal polymer film is thinner than that of the liquid crystal polymer fiber mat.

A liquid crystal polymer mat obtained by matting a conventional liquid crystal polymer powder containing no fibrous particles as described above does not contain fibrous particles having the axial direction of the molecular axis in the longitudinal direction. Thus, when such a liquid crystal polymer mat is heat-pressed, the axial direction of the molecules constituting the liquid crystal polymer in the liquid crystal polymer film is not pushed down. Thus, when a liquid crystal polymer film is produced using the conventional liquid crystal polymer powder containing no fibrous particles, the main alignment direction of each molecule constituting the liquid crystal polymer is not along the in-plane direction of the liquid crystal polymer film.

When the liquid crystal polymer fiber mat obtained by matting the conventional liquid crystal polymer powder containing no fibrous particles is heat-pressed, the bonding area is extremely small when the liquid crystal polymer powders are bonded to each other. For this reason, when the liquid crystal polymer film produced using the conventional liquid crystal polymer powder containing no fibrous particles is subjected to an external force, stress concentrates on a bonding portion between the liquid crystal polymer powders. Since the bonding area of the bonding portion is small, when the liquid crystal polymer film is subjected to an external force, the liquid crystal polymer film is broken at the bonding portion. As described above, the liquid crystal polymer film produced using the conventional liquid crystal polymer powder containing no fibrous particles has low strength and low toughness and folding strength. The liquid crystal polymer film cannot be used as a substrate for FPC, a diaphragm, or a damping plate.

### (Metal Foil Removing Step: S24)

Finally, the metal foil bonded to the liquid crystal polymer film may be removed by etching or the like as necessary. As a result, a single liquid crystal polymer film to which the metal foil is not bonded is obtained.

According to the method of producing a liquid crystal polymer film of the present embodiment, by producing a liquid crystal polymer film using a liquid crystal polymer powder containing fibrous particles having an average aspect ratio of 10 to 500 and an average diameter of 2 μm or less, which could not be conventionally realized, a liquid crystal polymer film having excellent folding strength and the like, which can be suitably used as a circuit board, can be obtained.

In the prior art, an LCP film has been produced by a melt extrusion method, a solution casting method, or the like. In these methods, it was necessary to use LCP having a relatively low melting point to allow melting in a production facility (LCP having an amide bond or the like). In contrast, in the method of producing an LCP film of the present embodiment, it is not necessary to melt the LCP, and thus the LCP having a high melting point as described above can be used. Therefore, for example, a liquid crystal polymer having a melting point more than 330° C. can be employed, and a liquid crystal polymer film containing the liquid crystal polymer having a melting point more than 330° C. and having excellent heat resistance can be produced.

### <Method of Producing Fiber Mat>

As shown in FIG. 7, a method of producing a fiber mat according to the present embodiment includes a dispersion step (S31) and a matting step (S32). The dispersion step (S31) is the same as the dispersion step (S21) in the method of producing a liquid crystal polymer film.

In the matting step (S32), the slurry-like liquid crystal polymer powder is molded into a liquid crystal polymer fiber mat by a papermaking method. In the papermaking method, the dispersing medium used in the dispersion step can be recovered and reused, and a fiber mat can be produced at low cost.

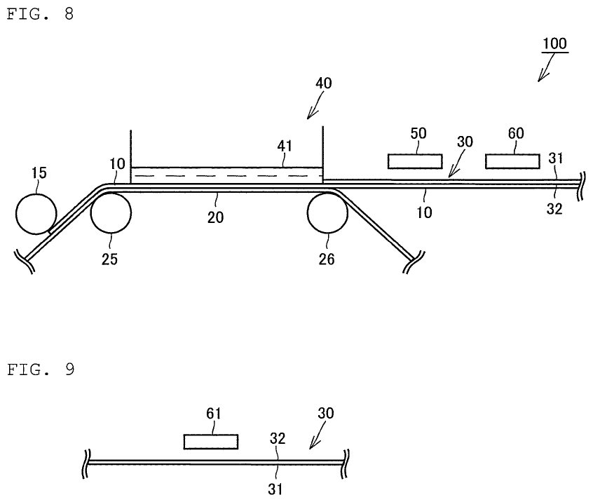

FIG. 8 is a view showing an example of the matting step of matting the liquid crystal polymer powder in a step of producing a fiber mat. Details of the matting step will be described with reference to FIG. 8.

As shown in FIG. 8, a paper machine 100 is used in the matting step. The paper machine 100 includes a supply roller 15 that supplies a microporous sheet 10, a winding roller (not illustrated) that collects the microporous sheet 10, a papermaking wire 20, conveying rollers 25 and 26, a storage portion 40 that stores a dispersing medium 41 in which the liquid crystal polymer powder is dispersed, a heating device 50, and a light irradiation device 60.

The papermaking wire 20, for example, is a papermaking net of about 80 to 100 mesh. That is, the papermaking wire 20 has a pore diameter of about 150 μm to 180 μm. The papermaking wire 20 is conveyed by the conveying rollers 25 and 26 arranged in the conveyance direction. The conveying roller 26 is disposed on the downstream side of the conveying roller 26. The papermaking wire 20 is conveyed by the conveying rollers 25 and 26 so as to pass through the storage portion 40.

The supply roller 15 supplies the microporous sheet 10 onto the papermaking wire 20. The microporous sheet 10 functions as a support that supports the liquid crystal polymer powder. The microporous sheet 10 disposed on the papermaking wire 20 is conveyed by the papermaking wire 20 so as to pass through the storage portion 40. The microporous sheet 10 having passed through the storage portion 40 is peeled off from the papermaking wire 20 and wound up by a winding roller.

The microporous sheet 10 has a mesh finer than that of the papermaking wire 20. The microporous sheet 10 is preferably about 157 mesh or more. That is, the microporous sheet 10 preferably has a pore diameter of about 100 μm or less. Thus, the fine liquid crystal polymer powder dispersed in the dispersing medium can be collected.

More preferably, the microporous sheet 10 preferably has a pore diameter of about 5 μm to 50 μm. When the pore diameter of the microporous sheet 10 is too small, the water-filterability is deteriorated, and the time required for dehydration becomes long. On the other hand, when the pore diameter of the microporous sheet 10 is too large, fine fibers (fine liquid crystal polymer powder) are hardly collected, and the yield becomes poor.

When the microporous sheet 10 having variations in pore diameter is selected, it affects the formation of the fiber mat to be formed, and therefore when high uniformity is required for the fiber mat, a mesh periodically knitted in a mesh shape is preferable. That is, as the microporous sheet 10, it is preferable to use a mesh having a uniform pore diameter and no bias in the location of pores.

As the microporous sheet 10, for example, a woven fabric mesh having a pore diameter of 50 μm or less can be used. As the woven fabric mesh, for example, a woven fabric mesh constituted of synthetic fibers such as polyester can be adopted.

As the microporous sheet 10, for example, a wet nonwoven fabric having a basis weight of 15 g/m² or less may be used. As the wet nonwoven fabric, a wet nonwoven fabric constituted of microfibers can be used. The microfiber is constituted of, for example, a synthetic fiber such as polyester.

The heating device 50 is disposed on the downstream side of the storage portion 40 in the conveyance direction. The heating device 50 heats and dries the liquid crystal polymer powder 30 that is subjected to papermaking on the microporous sheet 10. As a result, a fiber mat is formed on the microporous sheet 10.

The light irradiation device 60 is disposed on the downstream side of the heating device 50 in the conveyance direction. The light irradiation device 60 irradiates the fiber mat formed on the microporous sheet 10 with light. As the light irradiation device 60, for example, a flash lamp can be adopted.

The light irradiation device 60 preferably emits pulsed light. Since the pulsed light is absorbed by the surface (first main surface 31) of the fiber mat, the support (microporous sheet 10) supporting the fiber mat is not deteriorated by light irradiation. Thus, a material having a melting point lower than that of the fiber mat can be used as a support, and the range of selection of the support is widened. Since the fiber mat can be prevented from being fused to the support, the support can be repeatedly used. As the light irradiation device 60, a light irradiation device (PulseForge (registered trademark) 1300 manufactured by NovaCentrix) can be adopted.

The matting step (S32) includes a papermaking step, a peeling step, and a drying step, and may further include a light irradiation step. In the matting step (S32), first, the dispersed liquid crystal polymer powder is subjected to papermaking on the microporous sheet 10 in the papermaking step. Specifically, the microporous sheet 10 supplied onto the papermaking wire 20 is conveyed by the papermaking wire 20 and allowed to pass through the storage portion 40. At this time, the liquid crystal polymer powder dispersed in the dispersing medium 41 stored in the storage portion 40 is subjected to papermaking on the microporous sheet 10.

Subsequently, in the peeling step, the microporous sheet obtained by papermaking the dispersed liquid crystal polymer powder thereon is peeled off from the papermaking wire 20. Specifically, the microporous sheet 10 is wound by a winding roller to convey the microporous sheet 10 in a direction different from the direction of the papermaking wire 20. The papermaking wire 20 may be conveyed in a direction different from the direction of the microporous sheet 10 by the conveying roller 26.

Then, in the drying step, the liquid crystal polymer powder which is subjected to papermaking on the microporous sheet 10 is heated and dried by the heating device 50. As a result, a fiber mat 30 constituted of a liquid crystal polymer is formed on the microporous sheet 10.

Subsequently, in the light irradiation step, the first main surface 31 of the fiber mat 30 located on the side opposite to the side where the microporous sheet 10 is located is irradiated with light. As a result, the liquid crystal polymer powder located on the first main surface 31 side is fused. As a result, the strength of the fiber mat 30 is improved, and the fiber mat 30 can be carried to the next step without being damaged.

In addition, since only the liquid crystal polymer powder located on the surface layer on the first main surface 31 side is fused, the density of the entire fiber mat 30 is low. Accordingly, high air permeability and high collection efficiency can be secured.

The fiber mat 30 after light irradiation is wound by the winding roller in the winding step in a state of being disposed on the microporous sheet 10.

FIG. 9 is a view showing a step of irradiating a second surface of the fiber mat with light. As shown in FIG. 9, the matting step may further include a step of peeling the fiber mat 30 irradiated with light on the first main surface 31 from the microporous sheet 10, and irradiating the second main surface 32 of the fiber mat 30 located on the side opposite to the side where the first main surface 31 is located with light. In this step, the fine fibers located on the second main surface 32 side are fused by light irradiation from the light irradiation device 61. As the light irradiation device 61, a device similar to the light irradiation device 60 described above can be used. During light irradiation, the fiber mat 30 is irradiated while being conveyed.

When the liquid crystal polymer powder is fused on both the first main surface 31 side and the second main surface 32 side, the strength of the fiber mat 30 can be further improved.

When the fiber mat 30 is peeled off from the microporous sheet 10, the liquid crystal polymer powder is fused on the first main surface 31 side, and the fiber mat 30 has sufficient strength, so that the fiber mat 30 can be peeled off without being damaged. The fiber mat 30 thus prepared may be used as it is, or may be subjected to the heat-pressing step S23 of the method of producing a liquid crystal polymer film.

In the present embodiment, the fiber mat 30 is irradiated with light. When the liquid crystal polymer powder contained in the fiber mat contains a zirconium compound, light irradiation efficiency may be increased by the light absorption characteristics by the zirconium compound. Increasing the light irradiation efficiency can improve the breaking tension of the fiber mat.

### <<Method of Processing Liquid Crystal Polymer Film and Fiber Mat>>

In the present embodiment, the liquid crystal polymer film and the fiber mat are processed by laser irradiation to form a through-hole or a cut portion. For the laser irradiation, for example, a commercially available laser processing machine using CO₂ or a semiconductor as a laser oscillator can be used. The beam spot diameter of the laser beam can be changed by changing the lens of the laser processing machine. In order to perform fine processing, it is preferable that the beam spot diameter is small.

When the liquid crystal polymer film or the fiber mat contains a zirconium compound, the irradiation efficiency by laser irradiation is improved, and formation of a through-hole is facilitated.

### EXAMPLES

Hereinafter, the present disclosure will be described in more detail with reference to examples, but the present disclosure is not limited thereto.

### Example 1

### (Production of Liquid Crystal Polymer Powder)

In Example 1, first, pellets of a uniaxially oriented liquid crystal polymer (cylindrical pellet with diameter of 3 to 4 mm, melting point: 315° C., melt viscosity (MV): 17 Pa·s) were prepared as an LCP raw material. The material of the liquid crystal polymer is a block copolymer of parahydroxybenzoic acid and 4,6-hydroxynaphthoic acid. The melt viscosity of the liquid crystal polymer (LCP raw material) can be adjusted by the polymerization temperature and polymerization time during polymerization of the copolymer.

This LCP raw material was coarsely pulverized by a cutter mill (MF10, manufactured by IKA). The coarsely pulverized liquid crystal polymer was passed through a mesh having a diameter of 3 mm provided at a discharge port of the cutter mill to provide a coarsely pulverized liquid crystal polymer.

Then, the coarsely pulverized liquid crystal polymer was finely pulverized with a liquid nitrogen bead mill (LNM-08 manufactured by AIMEX CORPORATION, vessel capacity: 0.8 L). Specifically, 400 mL of media and 30 g of a coarsely pulverized liquid crystal polymer were put into a vessel, and pulverization treatment was performed at a rotation speed of 2000 rpm for 120 minutes. As the medium, beads made of zirconia (ZrO₂) having a diameter of 5 mm were used. Note that, in the liquid nitrogen bead mill, wet pulverizing treatment is performed in a state in which the coarsely pulverized liquid crystal polymer is dispersed in the liquid nitrogen. As described above, the coarsely pulverized liquid crystal polymer was pulverized in the liquid nitrogen bead mill to provide a granular finely pulverized LCP.

The particle size of the finely pulverized LCP was measured. The finely pulverized LCP dispersed in the dispersing medium was subjected to ultrasonic treatment for 10 seconds, and then set in a particle size distribution measuring device (LA-950 manufactured by HORIBA Ltd.) by a laser diffraction scattering method to measure the particle size. Note that, as the dispersing medium, Ekinen (registered trademark, Japan Alcohol Sales Co., Ltd.) which was a mixed solvent containing ethanol as a main agent was used. A measured value of D50 for the finely pulverized LCP was 23 μm.

Then, a dispersion solution obtained by dispersing the finely pulverized LCP in Ekinen was sieved with a mesh having an opening of 100 μm to remove the coarse particles contained in the finely pulverized LCP, and finely pulverized LCP passing through the mesh was recovered. A yield of the finely pulverized LCP by the removal of coarse particles was 85% by mass.

Then, the finely pulverized LCP from which the coarse particles were removed was dispersed in a 20% by mass ethanol aqueous solution. An ethanol slurry in which the finely pulverized LCP was dispersed was repeatedly crushed five times using a wet high-pressure crushing device under conditions with a nozzle diameter of 0.2 mm and a pressure of 200 MPa to be formed into fibers. As the wet high-pressure crushing device, a high-pressure crushing device (Nanoveta manufactured by Yoshida Kikai Kogyo Co., Ltd.) was used. As a result, a liquid crystal polymer powder dispersed in an ethanol aqueous solution was obtained.

### (Measurement of Melt Viscosity of Liquid Crystal Polymer Powder)

The liquid crystal polymer powder dispersed in the ethanol aqueous solution was recovered on a filter paper using a suction filtration device. The recovered liquid crystal polymer powder was transferred to an evaporating dish, and evaporated to dryness using a hot plate to provide a dried liquid crystal polymer powder. The measurement temperature was 80° C. The melt viscosity of the obtained dried liquid crystal polymer powder was measured.

The melt viscosity of the liquid crystal polymer powder was measured by a capilograph manufactured by Toyo Seiki Seisaku-sho, Ltd. in accordance with JIS K7199 under the following measurement conditions.

Temperature: 340° C.

Shear rate: 1000 Sec⁻¹

Capillary: Length: 20 mm/diameter: 1 mm

In this case, the measured melt viscosity of the liquid crystal polymer powder was 15 Pa·s.

### (Production of Liquid Crystal Polymer Film)

First, the paste of liquid crystal polymer powder was applied onto a copper foil and dried to form a web of liquid crystal polymer (liquid crystal polymer fiber mat) on the copper foil.

Specifically, first, terpineol having a mass 20 times the mass of the dispersed liquid crystal polymer powder was added to the ethanol aqueous solution in which the liquid crystal polymer powder was dispersed. Then, the aqueous solution was heated while being stirred to vaporize and remove water and ethanol. Thus, a liquid crystal polymer powder dispersed in terpineol was obtained. That is, the liquid crystal polymer powder was dispersed in terpineol as a dispersing medium to form a paste.

Then, a paste-like liquid crystal polymer was applied onto a roughened surface of an electrolytic copper foil (FWJ-WS-12 manufactured by Furukawa Electric Co., Ltd.) having a thickness of 12 μm. Then, the electrolytic copper foil applied with the paste-like liquid crystal polymer powder was heated to 130° C. on a hot plate to vaporize terpineol as a dispersing medium, and the paste-like liquid crystal polymer powder on the electrolytic copper foil was dried. As described above, a thin liquid crystal polymer fiber mat was formed on the electrolytic copper foil.

The paste-like liquid crystal polymer powder was further applied onto the thin liquid crystal polymer fiber mat. The applied paste-like liquid crystal polymer powder was dried in the same manner as a case where the paste-like liquid crystal polymer applied previously was dried. As described above, the application and drying were repeated a plurality of times to form the liquid crystal polymer fiber mat adjusted such that the basis weight was 35 g/m² on the electrolytic copper foil.

Then, the liquid crystal polymer fiber mat formed on the electrolytic copper foil was heat-pressed together with the electrolytic copper foil using a vacuum high-temperature press apparatus (KVHC manufactured by Kitagawa Seiki Co., Ltd.). Specifically, first, a release film was laminated on an opposite side to the electrolytic copper foil side of the liquid crystal polymer fiber mat formed on the electrolytic copper foil. As the release film, a polyimide film (Kapton (registered trademark) 100H manufactured by DU PONT-TORAY CO., LTD.) was used. Then, the liquid crystal polymer fiber mat on which the release film was laminated was set in the vacuum heating press apparatus at room temperature. The temperature of the set liquid crystal polymer fiber mat was raised to 305° C. at a rate of 7° C./min while the liquid crystal polymer fiber mat was pressed together with the release film and the electrolytic copper foil at a press pressure of 0.2 MPa. After the temperature reached 305° C., the liquid crystal polymer film was pressed together with the release film and the electrolytic copper foil at a press pressure of 6 MPa for 5 minutes while the temperature was maintained at 305° C. A size of the pressing member used for pressing was 170 mm square. After completion of the heat-pressing, the release film was removed to provide a liquid crystal polymer film formed on the electrolytic copper foil.

Finally, the electrolytic copper foil bonded to the liquid crystal polymer film was removed by etching using an aqueous solution of ferric chloride. Thus, a liquid crystal polymer film was obtained. The thickness of the liquid crystal polymer film was 25 μm.

### Examples 2 to 9 and Comparative Examples 1

In Examples 2 to 9 and Comparative Example 1, LCP pellets having melt viscosities of 23, 32, 35, 40, 47, 54, 63, 79, and 14, respectively, were used as raw materials (refer to Table 1). The melt viscosity of the liquid crystal polymer powder was changed by changing at least one of the polymerization temperature and the polymerization time during polymerization. A liquid crystal polymer powder was produced in the same manner as in Example 1 except for the above-described points, and a liquid crystal polymer film was obtained. The prepared liquid crystal polymer powders had melt viscosities of 20, 29, 33, 36, 45, 50, 60, and 77, respectively.

### [Observation of Liquid Crystal Polymer Powder]

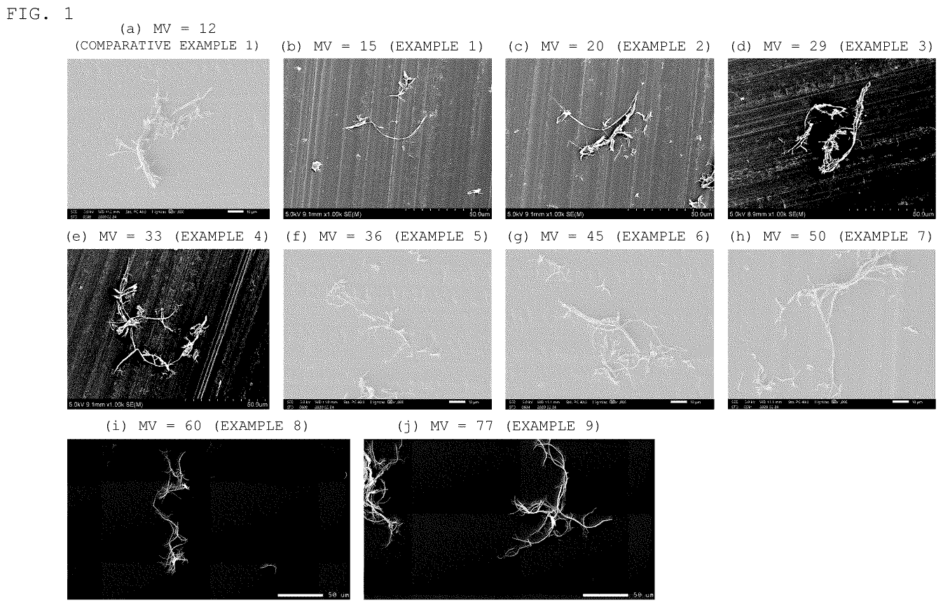

FIGS. 1(a) to 1(j) are photographs (scanning electron microscope images) obtained by photographing the liquid crystal polymer powder in Comparative Example 1 (MV=12), Example 1 (MV=15), Example 2 (MV=20), Example 3 (MV=29), Example 4 (MV=33), Example 5 (MV=36), Example 6 (MV=45), Example 7 (MV=50), Example 8 (MV=60), and Example 9 (MV=77). From the photograph in FIG. 1, it had been found that the liquid crystal polymer powders of Examples contain thin and long (small fiber diameter and large aspect ratio) fibrous particles as compared with the liquid crystal polymer powder of Comparative Example.

### [Measurement of Bulk Density of Liquid Crystal Polymer Powder]

The bulk density of each of the liquid crystal polymer powders according to Examples 1 to 9 and Comparative Example 1 was measured.

Specifically, first, a dispersion solution (solid content concentration: 0.1% by mass) was prepared by dispersing liquid crystal polymer powder in a dispersing medium (20% by mass ethanol solution). The dispersion solution was sufficiently stirred and then allowed to stand in a measuring cylinder for 2 hours or more, the volume of the portion occupied by the liquid crystal polymer powder in a state where the liquid crystal polymer powder was settled was read from the scale of the measuring cylinder, and the bulk density [mass/volume] was calculated from the measured value of the volume and the mass of the liquid crystal polymer powder (blending amount in the dispersion solution).

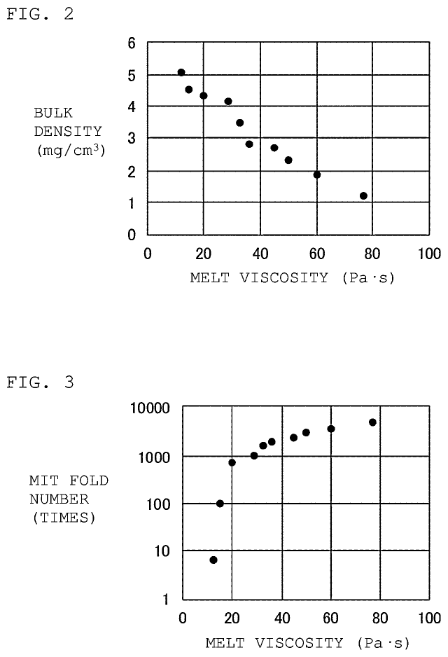

The measurement results of the bulk density of the liquid crystal polymer powder are shown in Table 1 and FIG. 2.

### [MIT Folding Fatigue Test]

The liquid crystal polymer film according to each of Examples 1 to 9 and Comparative Examples 1 was subjected to an MIT folding fatigue test using an MIT folding fatigue tester. The test was performed on a test film having a width of 10 mm and a thickness of 25 μm collected from each liquid crystal polymer film under the conditions of a load of 500 g, a curvature radius of 0.2 mm, a bending angle of 135 degrees, and a speed of 175 cpm.

The measurement results of the MIT fold number of the liquid crystal polymer film are shown in Table 1 and FIG. 3.

### [Measurement of Linear Expansion Coefficient]

The in-plane linear expansion coefficients of the liquid crystal polymer films according to each of Examples 1 to 9 and Comparative Example 1 were measured. Specifically, the in-plane (XY direction) linear expansion coefficient of the liquid crystal polymer film was measured according to JIS K 7197 by a TMA (thermomechanical analysis) method. Conditions of the TMA were as follows: a temperature was raised from room temperature to 150° C. at 10° C./min under a nitrogen atmosphere, a load was 10 g, and a sample shape was a strip shape (5 mm×15 mm).

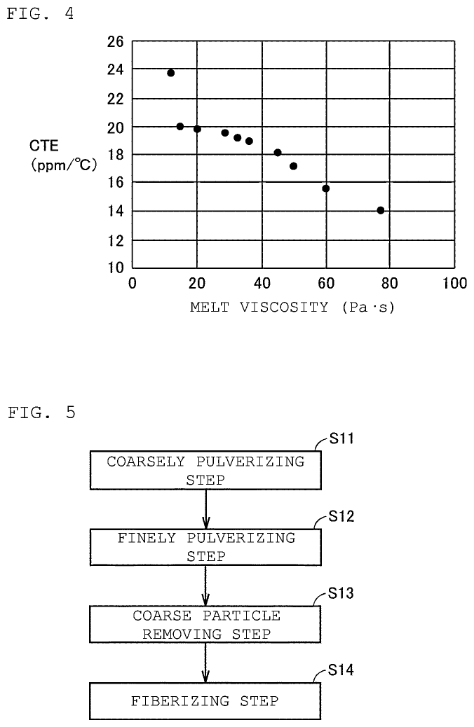

The measurement results of the linear expansion coefficient (CTE) of the liquid crystal polymer film are shown in Table 1 and FIG. 4.

TABLE 1

| | LCP | | | | | | |
|---|---|---|---|---|---|---|---|
| | raw | LCP powder | | | | LCP film | |
| | material | | | Average | Average | | MIT |
| | Melt | Melt | Bulk | fiber | fiber | | fold |
| | viscosity | viscosity | density | length | thickness | CTE | number |
| | (Pa · s) | (Pa · s) | (mg/cm³) | (μm) | (μm) | (ppm/° C.) | (times) |
| Comparative | 14 | 12 | 5.06 | 12.5 | 1.9 | 23.7 | 7 |
| Example 1 | | | | | | | |
| Example 1 | 17 | 15 | 4.51 | 18.0 | 1.8 | 20.0 | 100 |
| Example 2 | 23 | 20 | 4.32 | 21.5 | 1.8 | 19.8 | 713 |
| Example 3 | 32 | 29 | 4.15 | 23.0 | 1.8 | 19.5 | 1039 |
| Example 4 | 35 | 33 | 3.49 | 27.0 | 1.4 | 19.2 | 1571 |
| Example 5 | 40 | 36 | 2.82 | 29.5 | 1.3 | 19.0 | 1802 |
| Example 6 | 47 | 45 | 2.70 | 32.5 | 1.3 | 18.1 | 2323 |
| Example 7 | 54 | 50 | 2.32 | 34 | 1.3 | 17.2 | 2815 |
| Example 8 | 63 | 60 | 1.89 | 36.5 | 1.2 | 15.6 | 3480 |
| Example 9 | 79 | 77 | 1.20 | 45.5 | 1.2 | 14.1 | 4563 |

From the results shown in Table 1 and FIG. 3, it has been found that the liquid crystal polymer film according to Examples 1 to 7 in which the liquid crystal polymer powder having a melt viscosity of 15 to 77 Pa·s (particularly 20 to 77 Pa·s) was used had an MIT fold number of 100 times or more, and thus had improved folding strength. Therefore, it was confirmed that these liquid crystal polymer films had sufficient flexibility for use as a substrate of a flexible substrate or a diaphragm.

It is known that the MIT fold number of the LCP film produced in the same manner as in Example 1 with the fibrillar LCP described in Patent Document 1 is about 10 times, which is similar to that of Comparative Example.

From the results shown in Table 1 and FIG. 2, it has been found that the liquid crystal polymer powder increases in bulk density as the melt viscosity of the liquid crystal polymer powder increases. This is considered to be because the fibrous particles contained in the liquid crystal polymer powder become thin and long as the melt viscosity of the liquid crystal polymer powder increases. This is considered to improve the folding strength of the liquid crystal polymer film as described above.

In addition, from the results shown in Table 1 and FIG. 4, it has been found that the liquid crystal polymer film according to Examples 1 to 9 using the liquid crystal polymer powder having a melt viscosity of 15 to 77 Pa·s has a linear expansion coefficient of 20 or less.

Using a liquid crystal polymer film having a linear expansion coefficient similar to the linear expansion coefficient of the copper foil (about 18 to 20 ppm/° C.) as in the liquid crystal polymer film according to Examples 1 to 9 can suppress defects such as warpage due to thermal shrinkage in the liquid crystal polymer film to which the copper foil is bonded.

### Example 10

A liquid crystal polymer film of Example 10 was produced using the same raw materials as in Example 4. Example 4 is different from Example 4 only in that a pre-pressing step was performed as a step before heat-pressing the liquid crystal polymer fiber mat formed on the electrolytic copper foil together with the electrolytic copper foil using a vacuum high-temperature press apparatus. In the pre-pressing step, first, a step of pressing at normal temperature (7 MPa, 10 sec) and then pressing at 200° C. (7 MPa, 10 sec) was performed. Thereafter, the same treatment as in Example 4, specifically, a heat treatment was performed using a vacuum high-temperature press apparatus (KVHC manufactured by Kitagawa Seiki Co., Ltd.).

### (Evaluation)

For the fiber mats of Examples 4 and 10, the density was measured by the following method. In addition, the linear expansion coefficient (CTE) of the liquid crystal polymer film of Example 10 was measured by the same method as that used for the liquid crystal polymer film of Example 4 above, and the MIT folding fatigue test was performed. The measurement results are shown in Table 2.

### (Density Measurement of Fiber Mat)

The density of the fiber mat was calculated by measuring the weight and thickness of the liquid crystal polymer fiber mat formed on the electrolytic copper foil. Specifically, the weight of the fiber mat of the liquid crystal polymer was calculated by subtracting the weight of the electrolytic copper foil from the measured weight. The thickness was measured using a microgauge.

TABLE 2

| | Bulk density | CTE | MIT fold number |
|---|---|---|---|
| | (g/cm³ ) | (ppm/° C.) | (times) |
| Example 4 | 0.2 | 19.2 | 1571 |
| Example 10 | 1.2 | 15.2 | 3251 |

From the results shown in Table 2, it has been found that the linear expansion coefficient (CTE) of the liquid crystal polymer film decreases as the density of the fiber mat increases by performing the pre-pressing. By the pre-pressing, among the fibrous particles of the liquid crystal polymer powder in the fiber mat, the fibrous particles having the longitudinal direction in a direction along the thickness direction of the liquid crystal polymer fiber mat are pushed down in the in-plane direction of the copper foil. Thus, except for the molecules constituting the massive particles, the axial direction of each molecule constituting the liquid crystal polymer is oriented along the in-plane direction of the liquid crystal polymer film over the thickness direction of the liquid crystal polymer film. Therefore, in the molded liquid crystal polymer film, the main orientation direction of the molecules of the liquid crystal polymer tends to be along the in-plane direction of the copper foil, that is, the in-plane direction of the liquid crystal polymer film. As a result, the CTE of the liquid crystal polymer film of the present embodiment is reduced, and defects such as warpage due to thermal shrinkage can be suppressed in the liquid crystal polymer film to which the copper foil is bonded. In addition, it has been found that the liquid crystal polymer film is aligned in the in-plane direction, whereby improvement in MIT fold number can be expected.

### Example 11 and Comparative Example 2

### (Production of Fiber Mat of Example 11 and Comparative Example 2)

Using the liquid crystal polymer powder of Example 1 (melting point: 315° C.), water and ethanol were added in required amounts to prepare 2.2 g of the liquid crystal polymer powder with respect to 30 L of a 50 wt % ethanol aqueous solution, and the slurry-like liquid crystal polymer powder was molded into a fiber mat by a papermaking method. The liquid crystal polymer powder dispersed in a dispersing medium was subjected to papermaking on a microporous sheet of polyester mesh having a pore diameter of 11 μm using a square sheet machine 2555 manufactured by Kumagai Riki Kogyo Co., Ltd. as a paper machine. Subsequently, the fiber mat of Example 11 was molded on the microporous sheet by heating and drying at a temperature of 100° C. using a hot air dryer. The basis weight of the fiber mat was about 35 g/m².

The obtained fiber mat was peeled off from the microporous sheet, and heat-treated at temperatures of 280° C., 320° C., and 360° C. for 1 hour in a N₂ atmosphere. As a heating furnace, an inert oven was used.

Using the liquid crystal polymer powder (melting point: 315° C.) of Comparative Example 1, a fiber mat of Comparative Example 2 was prepared similarly to the fiber mat of Example 11, and heat-treated at temperatures of 280° C., 320° C., and 360° C. similarly to the fiber mat of Example 11. The breaking tension of the fiber mats of Example 11 and Comparative Example 2 was measured by the following method. The measurement results are shown in Table 3.

### (Measurement of Breaking Tension of Fiber Mat)

The breaking tension was measured for the fiber mats of Example 11 and Comparative Example 2 heat-treated at each temperature. The fiber mat after heat treatment was processed into a width of 20 mm per a length of 100 mm, and the breaking tension was measured using an autograph (AG-XDplus manufactured by Shimadzu Corporation). The measurement was performed at an initial length of 50 mm under the measurement conditions of a take-up speed of 0.33 mm/sec and a mode of pulling.

TABLE 3

| | Heat treatment | Breaking tension |
|---|---|---|
| | temperature (° C.) | (N/20 mm) |
| Example 11 | 280 | 2.0 |
| | 320 | 5.0 |
| | 360 | 8.1 |
| Comparative | 280 | 0.7 |
| Example 2 | 320 | 4.5 |
| | 360 | 8.0 |

From the results shown in Table 3, it has been found that in Example 11, a breaking tension of 0.8 N/20 mm or more was obtained when the heat treatment temperature was 280° C., which was equal to or less than the melting point.

### Examples 12 and 13

### (Production of Fiber Mat of Examples 12 and 13)

When the content of zirconia relative to the total amount of the liquid crystal polymer powder was W (% by weight), the content W of zirconia in the liquid crystal polymer powder of Example 1 was 0.0219% by weight. The content W of zirconia was calculated by the following method. When the liquid crystal polymer powder of Example 1 was subjected to a treatment for removing zirconia by the following method, the content W of zirconia calculated by the following method was 0.0005% by weight.

Fiber mats of Example 12 (produced using liquid crystal polymer powder without zirconia removal treatment) and Example 13 (produced using liquid crystal polymer powder with zirconia removal treatment) were produced using the liquid crystal polymer powder of Example 1 (without zirconia removal treatment, with zirconia removal treatment) similarly to Example 11. A light irradiation treatment was performed on the entire surface of the fiber mat at a table height of 10 mm for 3.5 msec using a light irradiation device (PulseForge (registered trademark) 1300 manufactured by NovaCentrix) at set voltages of 230 V, 250 V, and 270 V in place of the heat treatment of Example 11.

### (Method of Measuring Residual Amount of Zirconia)

In 500 mL of 1 mol % aqua regia, 40 g of liquid crystal polymer powder to be measured is dispersed, and is allowed to stand for 10 minutes. The powder and the solution are separated by suction filtration. Using the filtered solution, measurement was performed with an ICP emission spectrometer (ICPS-8100, manufactured by Shimadzu Corporation), and it was confirmed whether detection could be performed at a detection limit or more. A standard solution for a calibration curve was adjusted using ICP standard 1000 mg/LCeriptur (manufactured by Merck KGaA). As the standard solutions for calibration curves, 0, 0.25, 0.50, 1.0, and 2.0 [mg/L] were prepared. Measurement conditions by the ICP emission spectrometer included a twin sequential system, a high frequency output of 1.2 kW, a plasma gas flow rate of 14 L/min, an auxiliary gas flow rate of 1.2 L/min, a carrier gas flow rate of 0.7 L/min, a nebulizer coaxial type, and the measurement direction: lateral direction. The detection limit was 0.02 μg/L or less. The content of zirconium per weight of the liquid crystal polymer powder was calculated from the concentration of the ICP solution. The Zr amount (molecular weight: 91) was converted as a ZrO₂ (zirconia) amount (molecular weight: 123) using the following calculation formula.

$$W ( \% by weight ) = ( zirconium ion concentration ( g / L ) of the measured solution ) \times ( 123 \div 91 ) \times 0.5 L \div 40 g \times 100$$

### (Method of Removing Zirconium)

In 500 mL of 1 mol % aqua regia, 40 g of the prepared liquid crystal polymer powder is dispersed, and is allowed to stand for 10 minutes. The powder and the solution are separated by suction filtration, and only the powder is dispersed in 500 mL of pure water. The dispersed powder is separated again by suction filtration. This was repeated three times, and the resultant product was heated on a hot plate to 100° C. to evaporate moisture, thereby producing a liquid crystal polymer powder from which zirconia was removed.

### (Evaluation)

### (Measurement of Breaking Tension)

For the fiber mats of Examples 12 and 13 after the light irradiation treatment, the breaking tension was measured by the above method. The measurement results are shown in Table 4.

TABLE 4

| | | | Set voltage | |
|---|---|---|---|---|
| | Removal | Content of | for light | Breaking |
| | treatment | zirconia | irradiation | tension |
| | of zirconia | (% by weight) | treatment (V) | (cN/20 mm) |
| Example 12 | Without | 0.0219 | 230 | 5 |
| | Without | 0.0219 | 250 | 13 |
| | Without | 0.0219 | 270 | 23 |
| Example 13 | With | 0.0005 | 230 | 4 |
| | With | 0.0005 | 250 | 10 |
| | With | 0.0005 | 270 | 15 |

From the results shown in Table 4, it was found that in Example 12, a fiber mat having a high breaking tension was obtained as compared with Example 13.

### (Laser Processability)

The fiber mats of Examples 12 and 13 after light irradiation (those having a light irradiation treatment setting voltage of 230 V) were subjected to laser processing by performing laser irradiation under the following conditions. A KrF excimer laser having a wavelength of 248 nm was generated by CoMPexPro series (manufactured by Coherent Inc.), and the generated laser was condensed in a 1 mm square region by a reflection lens and a condenser lens. The produced film was placed at a focal length for condensing light, and the energy of the laser was set such that the energy per irradiation (pulse) was 150 mJ/mm². Then, the energy corresponding to seven irradiations (pulses) was applied. By such laser processing, the fiber mat of Example 12 had a through-hole, and the fiber mat of Example 13 could be cut although the through-hole was not formed. From the above results, it has been found that the laser processing could be performed more efficiently in Example 12 in which the removal treatment of zirconia was not performed.

In the description of the above embodiment, combinable configurations may be combined with each other.

The embodiments and examples disclosed herein are all to be considered by way of examples in all respects, but not limiting. The scope of the present disclosure is specified by the claims, but not the above description, and intended to encompass all modifications within the spirit and scope equivalent to the claims.

<1> A liquid crystal polymer powder including fibrous particles including a liquid crystal polymer, wherein the liquid crystal polymer powder has a melt viscosity of 15 to 77 Pa·s.

<2> The liquid crystal polymer powder according to <1>, wherein the melt viscosity of the liquid crystal polymer powder is 20 to 77 Pa·s.

<3> The liquid crystal polymer powder according to <1> or <2>, wherein when a fiber mat is formed using the liquid crystal polymer powder, and heat treatment is performed at a temperature equal to or less than the melting point of the liquid crystal polymer powder, the fiber mat has a breaking tension of 1.0 N/20 mm or more.

<4> The liquid crystal polymer powder according to any one of <1> to <3>, further including a zirconium compound.

<5> The liquid crystal polymer powder according to <4>, wherein the zirconium compound is contained in the liquid crystal polymer powder in an amount of 0.001% by weight to 0.1% by weight, with respect to a total amount of the liquid crystal polymer powder.

<6> A method of producing a liquid crystal polymer powder, including: pulverizing a liquid crystal polymer raw material in a state of being dispersed in liquid nitrogen to provide a granular finely pulverized liquid crystal polymer; and crushing the finely pulverized liquid crystal polymer with a wet high-pressure crushing device to provide a liquid crystal polymer powder, wherein the liquid crystal polymer raw material has a melt viscosity of 15 to 79 Pa·s.

<7> The method of producing a liquid crystal polymer powder according to <6>, wherein the melt viscosity of the liquid crystal polymer raw material is 20 to 79 Pa·s.

<8> The method of producing a liquid crystal polymer powder according to <6> or <7>, wherein the liquid crystal polymer raw material is in a form of pellets including a liquid crystal polymer.

<9> The method of producing a liquid crystal polymer powder according to any one of <6> to <8>, wherein the liquid crystal polymer raw material dispersed in the liquid nitrogen is pulverized using a medium.

<10> The method of producing a liquid crystal polymer powder according to any one of <6> to <9>, wherein a melting point of the liquid crystal polymer raw material is higher than 300° C., the method further including coarsely pulverizing the liquid crystal polymer raw material before the pulverizing in the state of being dispersed in the liquid nitrogen.

<11> A liquid crystal polymer powder obtained by the method according to any one of <6> to <10>.

<12> A liquid crystal polymer film including a liquid crystal polymer powder, wherein an MIT fold number is 100 times or more.

<13> The liquid crystal polymer film according to <12>, wherein an in-plane linear expansion coefficient of the liquid crystal polymer film is 20 ppm/° C. or less.

<14> A fiber mat including a liquid crystal polymer powder, wherein a breaking tension of the fiber mat is 1.0 N/20 mm or more when a heat treatment is performed at a temperature equal to or less than a melting point of the liquid crystal polymer powder.

<15> The fiber mat according to <14>, wherein a density of the fiber mat is 0.1 to 1.5 g/cm³.

<16> A method of producing a liquid crystal polymer film, including: dispersing the liquid crystal polymer powder according to any one of <1> to <5> and <11> in a dispersing medium to form the liquid crystal polymer powder into a paste form or a slurry form; drying the paste or slurry liquid crystal polymer powder to form a liquid crystal polymer fiber mat; and heat-pressing the liquid crystal polymer fiber mat to form a liquid crystal polymer film.

<17> The method of producing a polymer film according to <16>, further comprising applying the paste or slurry to a copper foil.

<18> The method of producing a liquid crystal polymer film according to <17>, wherein the liquid crystal polymer fiber mat is heat-pressed together with the copper foil.

<19> The method of producing a liquid crystal polymer film according to any one of <16> to <18>, further including performing pre-pressing at a temperature of 220° C. or less before the heat-pressing step.

<20> The method of producing a liquid crystal polymer film according to any one of <16> to <19>, wherein the paste or slurry is formed into the liquid crystal polymer fiber mat by a papermaking method.

<21> A liquid crystal polymer film obtained by the method according to any one of <16> to <20>.

### DESCRIPTION OF REFERENCE SYMBOLS

10: Microporous sheet
15: Supply roller
20: Papermaking wire
25, 26: Conveying roller
30: Fiber mat
31: First main surface
32: Second main surface
40: Storage portion
41: Dispersing medium
50: Heating device
60: Light irradiation device
100: Paper machine

1. A liquid crystal polymer powder comprising:
fibrous particles including a liquid crystal polymer,
wherein the liquid crystal polymer powder has a melt viscosity of 15 to 77 Pa·s.

2. The liquid crystal polymer powder according to claim 1, wherein the melt viscosity of the liquid crystal polymer powder is 20 to 77 Pa·s.

3. The liquid crystal polymer powder according to claim 1, wherein a molecule of the liquid crystal polymer has a negative coefficient of thermal expansion in an axial direction of a molecular axis thereof and a positive coefficient of thermal expansion in a radial direction of the molecular axis.

4. The liquid crystal polymer powder according to claim 1, wherein an average fiber thickness of the liquid crystal polymer powder is 1.2 μm to 1.8 μm.

5. The liquid crystal polymer powder according to claim 1, further comprising a zirconium compound.

6. The liquid crystal polymer powder according to claim 5, wherein the zirconium compound is contained in the liquid crystal polymer powder in an amount of 0.001% by weight to 0.1% by weight, with respect to a total amount of the liquid crystal polymer powder.

7. A method of producing a liquid crystal polymer powder, the method comprising:
pulverizing a liquid crystal polymer raw material in a state of being dispersed in liquid nitrogen to provide a pulverized liquid crystal polymer; and
crushing the pulverized liquid crystal polymer with a wet pressure crushing device to provide a liquid crystal polymer powder,
wherein the liquid crystal polymer raw material has a melt viscosity of 15 to 79 Pa·s.

8. The method of producing a liquid crystal polymer powder according to claim 7, wherein the melt viscosity of the liquid crystal polymer raw material is 20 to 79 Pa·s.

9. The method of producing a liquid crystal polymer powder according to claim 7, wherein the liquid crystal polymer raw material dispersed in the liquid nitrogen is pulverized using a medium.

10. The method of producing a liquid crystal polymer powder according to claim 7, wherein
a melting point of the liquid crystal polymer raw material is higher than 300° C.,
the method further comprising initially pulverizing the liquid crystal polymer raw material before the pulverizing in the state of being dispersed in the liquid nitrogen.

11. A liquid crystal polymer film comprising the liquid crystal polymer powder according to claim 1, wherein an MIT fold number is 100 times or more.

12. The liquid crystal polymer film according to claim 11,
wherein an in-plane linear expansion coefficient of the liquid crystal polymer film is 20 ppm/° C. or less.

13. The liquid crystal polymer film according to claim 11,
wherein an in-plane linear expansion coefficient of the liquid crystal polymer film is 14.1 ppm/° to 20 ppm/° C.

14. A fiber mat comprising the liquid crystal polymer powder according to claim 1, wherein a breaking tension of the fiber mat is 1.0 N/20 mm or more when a heat treatment is performed at a temperature equal to or less than a melting point of the liquid crystal polymer powder.

15. The fiber mat according to claim 14, wherein a density of the fiber mat is 0.1 to 1.5 g/cm³.

16. A method of producing a liquid crystal polymer film, the method comprising:
dispersing a liquid crystal polymer powder in a dispersing medium to form the liquid crystal polymer powder into a paste form or a slurry form, the liquid crystal polymer powder comprising: fibrous particles including a liquid crystal polymer, and wherein the liquid crystal polymer powder has a melt viscosity of 15 to 77 Pa·s;
drying the paste or slurry to form a liquid crystal polymer fiber mat; and
heat-pressing the liquid crystal polymer fiber mat to form a liquid crystal polymer film.

17. The method of producing a polymer film according to claim 16, further comprising applying the paste or slurry to a copper foil.

18. The method of producing a liquid crystal polymer film according to claim 17, wherein the liquid crystal polymer fiber mat is heat-pressed together with the copper foil.

19. The method of producing a liquid crystal polymer film according to claim 16, further comprising performing pre-pressing at a temperature of 220° C. or less before the heat-pressing.

20. The method of producing a liquid crystal polymer film according to claim 16, wherein the paste or slurry is formed into the liquid crystal polymer fiber mat by a papermaking method.
